(19) United States
(12) Patent Application Publication
(10) Pub. No.: US 2026/0032742 A1
(43) Pub. Date: Jan. 29, 2026

(54) METHODS AND APPARATUS FOR ENABLING N3GPP COMMUNICATION BETWEEN REMOTE WTRU AND RELAY WTRU

(71) Applicant: INTERDIGITAL PATENT HOLDINGS, INC., Wilmington, DE (US)

(72) Inventors: Jung Je Son, Warrington, PA (US); Saad Ahmad, Montreal (CA); Michelle Perras, Montreal (CA); Samir Ferdi, Kirkland (CA); Taimoor Abbas, Sainte-Julie (CA)

(73) Assignee: INTERDIGITAL PATENT HOLDINGS, INC., Wilmington, DE (US)

(21) Appl. No.: 19/099,129

(22) PCT Filed: Jul. 28, 2023
(86) PCT No.: PCT/US2023/028957

§ 371 Date: Jan. 28, 2025

Related U.S. Application Data
(60) Provisional application No. 63/393,479, filed on Jul. 29, 2022.

(51) Int. Cl. H04W 76/14; H04W 12/06; H04W 12/08; H04W 88/04

(52) U.S. Cl. CPC H04W 76/14; H04W 12/06; H04W 12/08; H04W 88/04

(57) ABSTRACT

A relay wireless transmit/receive unit. WTRU, sends (1110), to a network entity, a message indicating support for relay for ProSe service over a non-3GPP, N3GPP, connection. The relay WTRU receives (1110), from the network entity, policy information for WTRU to Network relay over N3GPP. The policy information comprises a relay service code, RSC, N3GPP identity information. and supported security mode for a N3GPP access. The relay WTRU broadcasts (1130) discovery information over a PC5 connection and establishes (1140), with a remote WTRU associated with the RSC, a PC5 connection for ProSe direct communication including a security association with the remote WTRU. The relay WTRU performs (1150) security bootstrapping of N3GPP access over the PC5 connection with the remote WTRU, establishes (1160) a N3GPP connection for ProSe direct communication, and establishes (1170) a new PDU session or changes (1170) an existing PDU session for relaying traffic of the remote WTRU to the network entity.

### CROSS REFERENCE TO RELATED APPLICATIONS

This application claims the benefit of U.S. Provisional Application No. 63/393,479, filed Jul. 29, 2022, the contents of which are incorporated herein by reference.

### BACKGROUND

A proximity services (ProSe) WTRU-to-Network Relay entity provides the functionality to support connectivity to the network for remote WTRUs. If a remote WTRU is out of New Radio (NR) coverage and cannot communicate with the network directly, or is in NR coverage but prefers to use a relayed PC5 interface for communication, the remote WTRU may discover and select a ProSe WTRU-to-Network Relay. The remote WTRU may establish a PC5 unicast connection for ProSe direct communication with the ProSe WTRU-to-Network Relay and access the network via the ProSe WTRU-to-Network Relay.

### SUMMARY

A method and apparatus for relay for ProSe service over a non-3GPP (N3GPP) connection is disclosed. A relay wireless transmit/receive unit (WTRU) may send, to a network entity, a message indicating support for relay for ProSe service over a non-3GPP (N3GPP) connection. The relay WTRU may receive, from the network entity, policy information for WTRU to Network relay over N3GPP. The policy information may comprise a relay service code (RSC), N3GPP identity information, and supported security mode for a N3GPP access technology. The relay WTRU may broadcast discovery information over a PC5 connection. The discovery information may comprise the RSC, the N3GPP identity information, and the supported security mode for a N3GPP access technology. The relay WTRU may establish, with a remote WTRU associated with the RSC, a PC5 connection for ProSe direct communication including a security association with the remote WTRU. The relay WTRU may perform security bootstrapping of N3GPP access over the PC5 connection with the remote WTRU. The security bootstrapping may comprise exchanging messages with the remote WTRU to share N3GPP security credentials. The N3GPP security credentials may be based on a supported security mode of the N3GPP access technology. The relay WTRU may establish a N3GPP connection for ProSe direct communication. The relay WTRU may establish a new packet data unit (PDU) session or change an existing PDU session for relaying traffic of the remote WTRU to the network entity. The network entity may be a 5G core network entity and may be one or more of an Access and Mobility Management Function (AMF), a Session Management Function (SMF), a Policy and Control Function (PCF), a ProSe server, a Direct Discovery Name Management Function (DDNMF), or a Unified Data Management (UDM). The policy information may comprise: ProSe application and service information, an indication of which N3GPP access technologies are supported, which N3GPP access technologies may be used simultaneously, and security credential information. The RSC may be associated with the ProSe application and service information. The relay WTRU may receive N3GPP quality of service (QOS) information. Available relay WTRU information may be sent by a policy and control function (PCF) to the remote WTRU. The available relay WTRU information may comprise a list of available relay WTRUs. The list of available relay WTRUs may be based on a location or time. The security bootstrapping may be performed using assistance information received from a ProSe server. The establishing a new packet data unit (PDU) session or changing an existing PDU session may be based on quality of service (Qos) information. The relay WTRU may send information to a session management function (SMF) indicating that the N3GPP connection for ProSe direct communication was established. The relay WTRU may receive information regarding an aggregated maximum bit rate (AMBR) for a PDU session. The relay WTRU may manage the N3GPP connection with the remote WTRU so that a bit rate of the PDU session does not exceed the AMBR.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of a reference model of a 5G/NextGen network;

FIG. 3 is an example of an architecture model using a Layer-2 UE-to-Network Relay;

FIG. 4 is an example of End-to-End Control Plane for a Remote UE using Layer-2 UE-to-Network Relay;

FIG. 5 is an example of an architecture model using a Layer-3 UE-to-Network Relay;

FIG. 6 is an example of End-to-End Control Plane for a Remote UE using Layer-3 UE-to-Network Relay;

FIG. 7 is an example of a remote UE connected to a relay UE via N3GPP access;

FIG. 8 shows an example of provisioning and connection establishment via 3GPP PC5 signaling;

FIG. 9 shows an example method of Discovery and Connection Establishment via N3GPP PC5 signaling;

FIG. 10 shows an example method of switching direct communication between 3GPP and N3GPP access;

FIG. 11 shows an example method of establishing a relay connection for N3GPP direct communication; and

FIG. 12 shows an example method of 3GPP PC5 assisted discovery and N3GPP link establishment.

### DETAILED DESCRIPTION

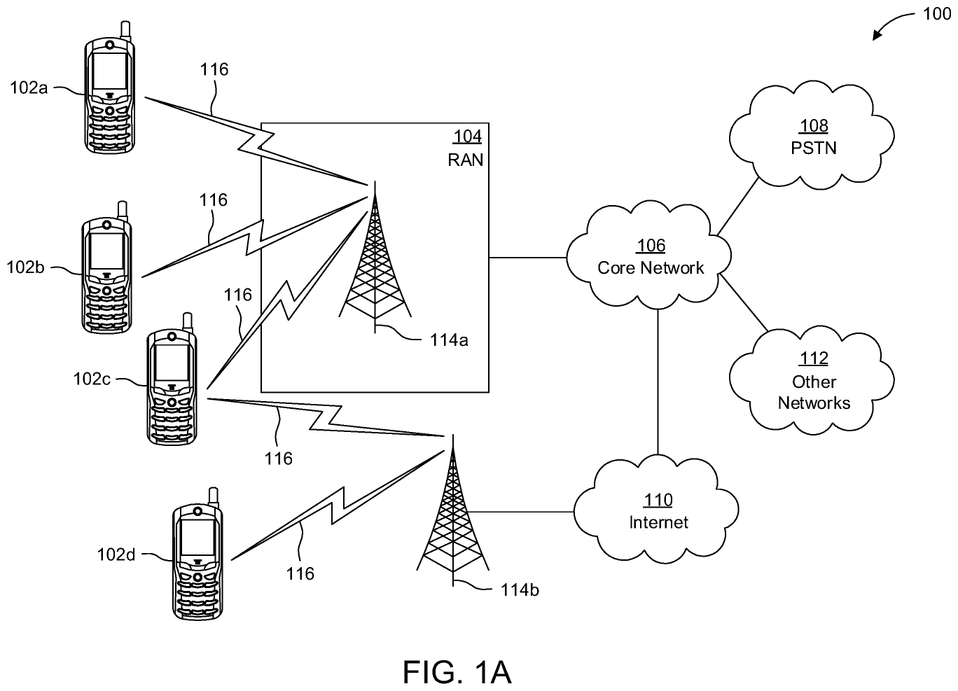

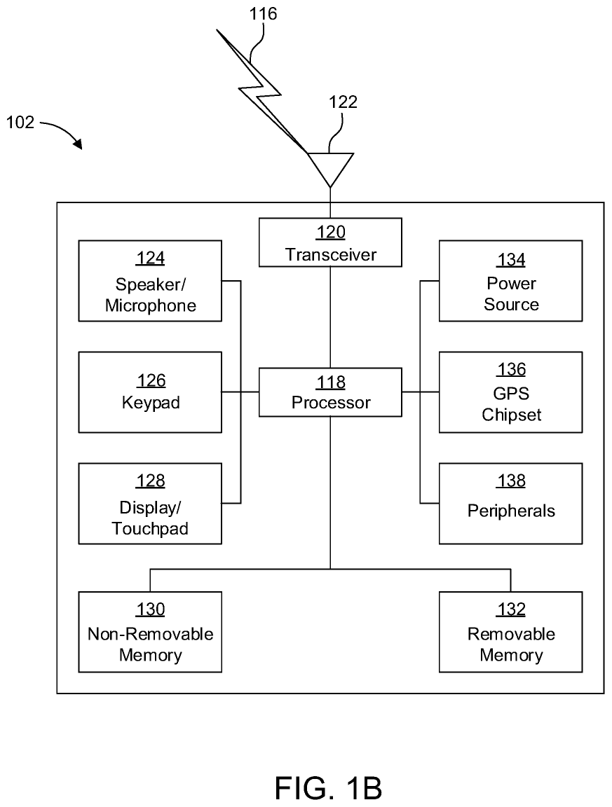

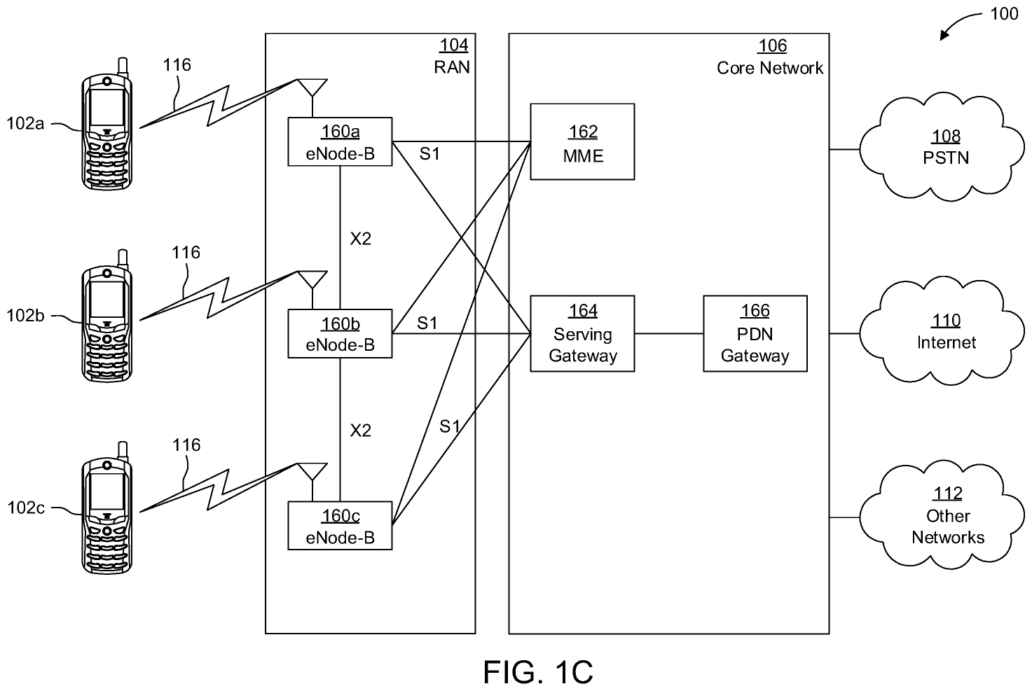

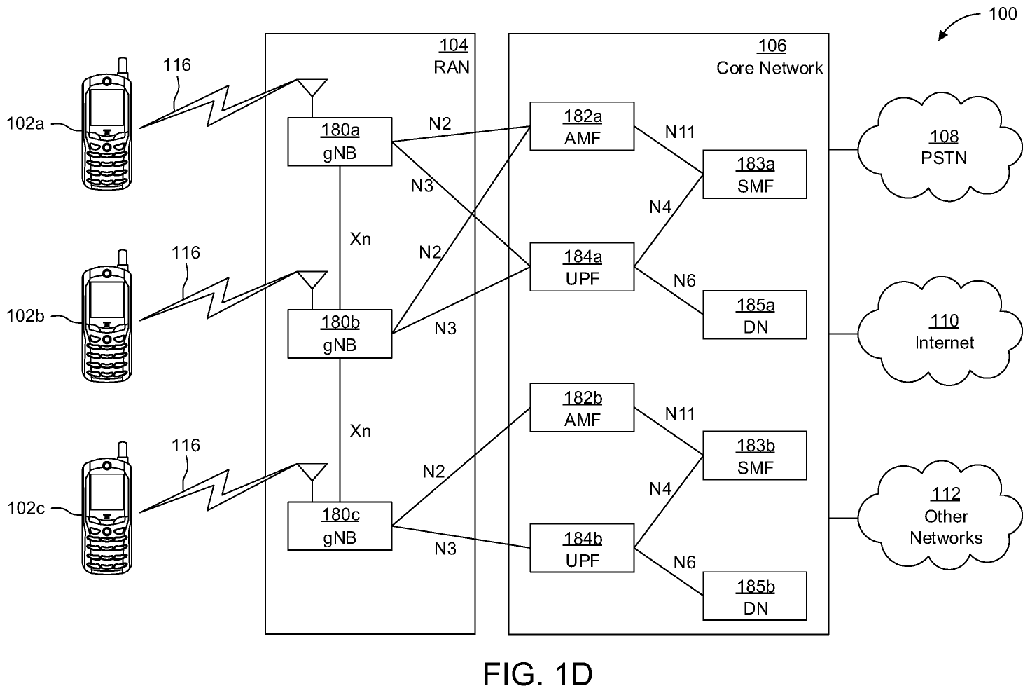

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

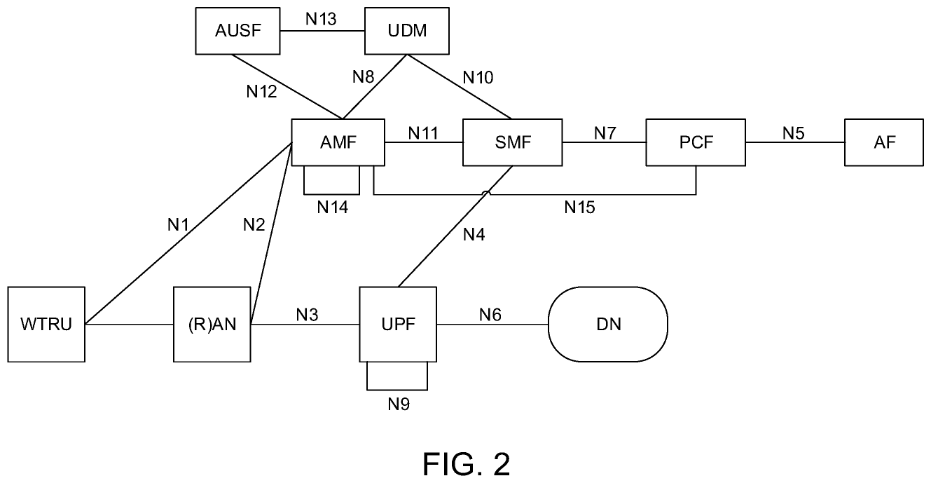

FIG. 2 shows an example of a reference model of a potential architecture of a 5G or NextGen network. RAN herein refers to a radio access network based on the 5G RAT or Evolved E-UTRA that connects to the NextGen core network. The Access Control and Mobility Management Function (AMF) may include at least the following functionalities: registration management, connection management, reachability management, and mobility management. The Session Management Function (SMF) may include at least the following functionalities: session management (including session establishment, modify and release), WTRU IP address allocation, and selection and control of UP function. The User plane function (UPF) may include at least the following functionalities: packet routing & forwarding, packet inspection, and traffic usage reporting.

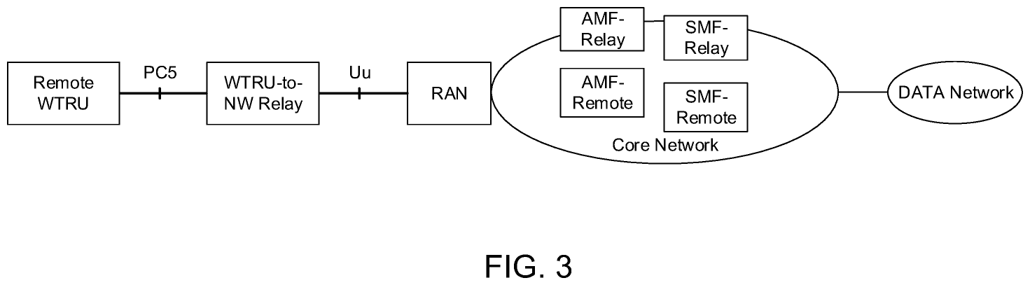

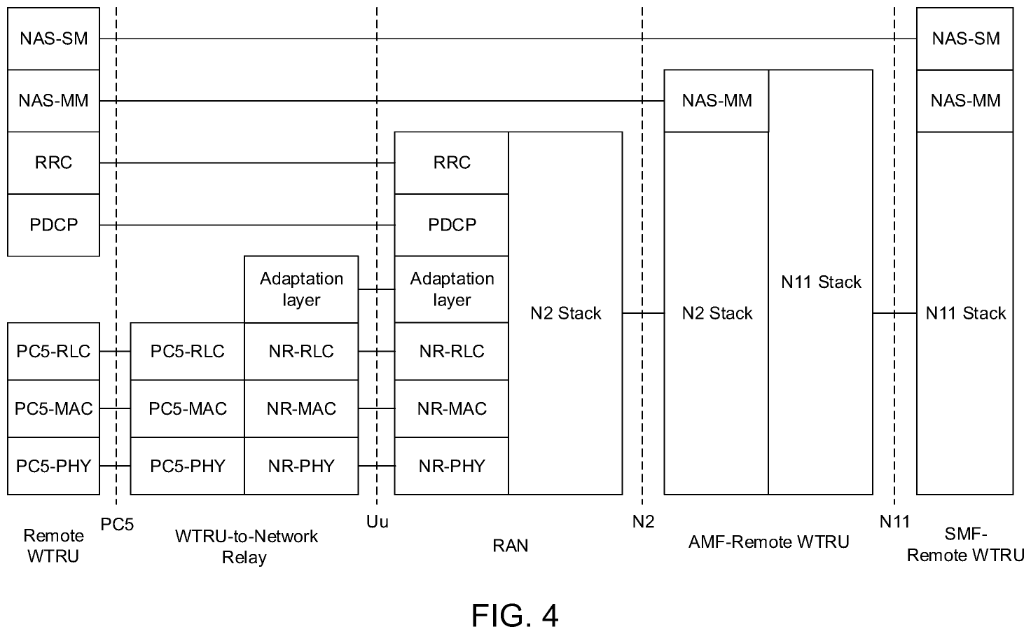

A Layer-2 WTRU-to-Network (NW) Relay may provide the functionality to support connectivity to the network for Layer-2 Remote WTRUs via AS layer forwarding as shown in FIG. 3 and FIG. 4. In FIG. 3, a remote WTRU has a PC5 connection to a WTRU-to-NW Relay. The WTRU-to-NW Relay has a Uu connection to the RAN. The core network comprises an AMF-Relay (i.e., AMF of WTRU-to-NW Relay), a SMF-Relay (i.e., SMF of WTRU-to-NW Relay), an AMF-Remote (i.e., AMF of Remote WTRU), and a SMF remote (i.e., SMF of Remote WTRU). The core network has a connection to a data network.

In FIG. 4, a remote WTRU has a PC5 connection to a WTRU-to-NW Relay. The WTRU-to-NW Relay has Uu connection to the RAN. The RAN has a N2 connection to the AMF-Remote WTRU. The AMF-Remote WTRU has a N11 connection to the SMF-Remote WTRU. The control plane protocol stack is shown in FIG. 4 and is an example of End-to-End Control Plane for a Remote WTRU using Layer-2 WTRU-to-NW Relay.

After a PC5 session is established between a Layer-2 Remote WTRU and a Layer-2 WTRU-to-NW Relay, the Layer-2 WTRU-to-NW Relay may forward RRC signaling and traffic between the Layer-2 Remote WTRU and the RAN. When receiving signaling via a Uu interface, the RAN may determine whether the signaling received is from the WTRU-to-NW Relay itself or from the Remote WTRU via the WTRU-to-NW Relay. The RAN may perform corresponding procedures with an AMF-Relay (e.g. the AMF which serves the WTRU-to-NW Relay) or AMF-Remote WTRU (e.g. the AMF which serves the Remote WTRU). The AMF-Relay and AMF-Remote WTRU may belong to different core networks. In order to provide AS layer forwarding, the Layer-2 WTRU-to-NW Relay must stay in a connected mode if any Layer-2 Remote WTRU is in a connected mode.

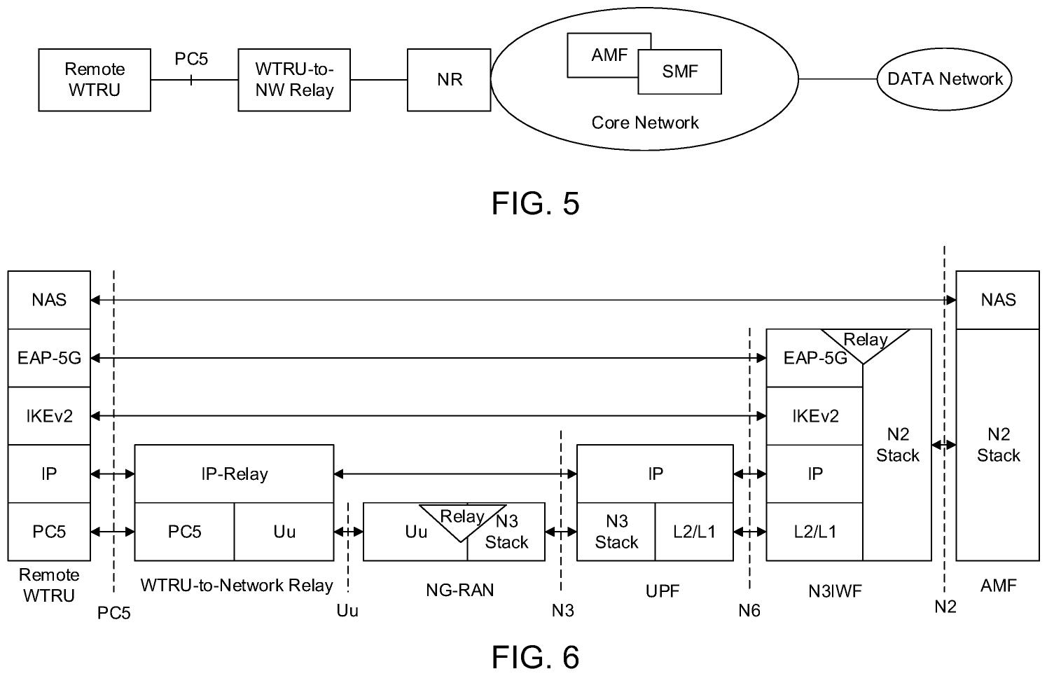

The Layer-3 WTRU-to-NW Relay provides the functionality to support connectivity to the network for Layer-3 Remote WTRUs via IP layer forwarding, as shown in FIG. 5 and FIG. 6.

After a PC5 session is established between the Layer-3 Remote WTRU and Layer-3 WTRU-to-NW Relay, the Layer-3 WTRU-to-NW Relay establishes a new PDU session or modifies an existing PDU session to provide connectivity between the Layer-3 Remote WTRU and the core network. For example, if an IP type PDU session is established for the Layer-3 Remote WTRU, the Layer-3 WTRU-to-NW Relay allocates an IP address/prefix to the Layer-3 Remote WTRU. Then the Layer-3 Remote WTRU uses this IP connection to access the internet or access back to the Layer-3 Remote WTRU's core network.

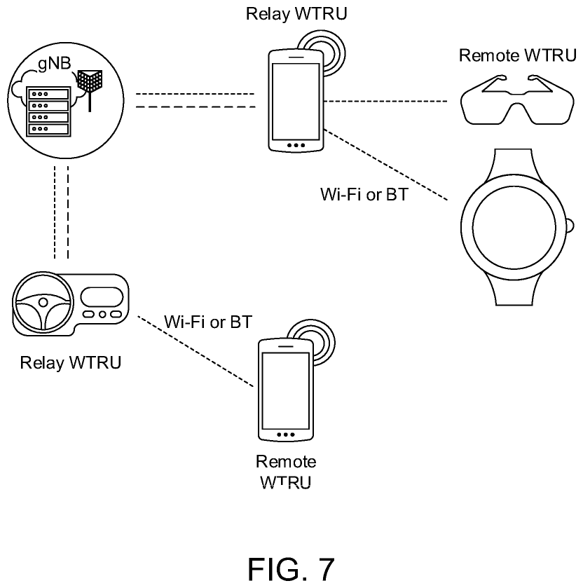

The current relay scenario may be extended to support devices connected via non-3GPP (N3GPP) access (e.g. Bluetooth (BT) or WiFi). FIG. 7 shows some of these scenarios. As shown in FIG. 7, the Remote WTRU is connected to the Relay WTRU (e.g. L3 WTRU-to NW relay scenario) via N3GPP access (e.g. WiFi or BT). The small dashed lines in FIG. 7 shows the data from the N3GPP connection whereas the large dashed lines in FIG. 7 shows the data from the 3GPP devices. XR services (e.g. smart glasses connected to the network via smart phone as a relay WTRU) is one of the use cases for this scenario. It may have stringent performance requirements for throughput, latency and reliability. Another possible use case is an automotive scenario (e.g. a smart phone connected to the network via a vehicle as a relay WTRU).

A transmission path, as shown in FIG. 7, between the remote WTRU and the relay WTRU is a N3GPP connection (e.g. WiFi or BT). The path between the relay WTRU and the network is via a 3GPP path. A WTRU-to-NW relay should be able to provide support to meet the performance requirements over N3GPP especially when supporting use cases which require high QoS (e.g. XR scenario or automotive scenario). These scenarios have strict performance requirements in terms of latency, throughput and reliability.

A remote WTRU needs to discover a relay WTRU which supports N3GPP communication and setup a N3GPP connection with the relay WTRU. Procedures need to be defined between the remote WTRU and the relay WTRU for such communication. The relay WTRU may need to interact with the network to facilitate this N3GPP connection between the remote WTRU and the relay WTRU. Such interactions also need to be defined.

As adversary may impersonate a relay providing N3GPP access for a ProSe relay. Therefore, the remote WTRU needs to ensure the relay is authorized to provide a ProSe relay service using a N3GPP connection and vice versa. To avoid eavesdropping or tampering of the communication over a N3GPP connection, the remote WTRU and relay also need to be able to establish a secure N3GPP connection for the ProSe relay service. For example, the remote WTRU and relay need to ensure at least the same level of protection when the data is exchanged over the N3GPP connection to avoid a downgrade of the security when the communication between the remote WTRU and relay is switched between a 3GPP and N3GPP connection.

Based on various conditions or triggers, a N3GPP connection between a remote WTRU and a relay WTRU may need to be switched to a 3GPP PC5 connection and vice versa. For example, different charging may be applied to a N3GPP connection compared to a PC5 connection or the required QoS may not be supported by PC5, which may favor usage of a N3GPP connection. If an expected service data rate is not high, it may be beneficial to select Bluetooth (BT) or Bluetooth Low Energy (BLE) for a relay service for efficient battery consumption of a remote WTRU. For high demanding service, WiFi or WiFi Direct technology may be better than a PC5 to transfer the data to a remote WTRU through a relay WTRU.

The remote WTRU, the relay and the network may be involved in the procedures to switch between N3GPP and 3GPP connection. The service requirements for the communication between the remote WTRU and the relay WTRU need to be ensured. The embodiments described herein take this requirement into account.

The embodiment described herein assume that a WTRU supports PC5 signaling. The PC5 signaling may be supported by the ProSe layer in the WTRU. The ProSe layer may interact with the N3GPP stack in the WTRU. The ProSe layer may be implemented on top of the N3GPP stack. This is applicable to both the 3GPP and N3GPP WTRUs. The WTRUs in the embodiments described herein may be, for example, ProSe WTRUs, WTRUs as part of a Personal loT network (PIN) or ProSe WTRUs supporting ranging/SL positioning functionality. In case of a PIN, the WTRUs may be a PIN element, a PIN element with Gateway Capability (PEGC), or a PIN element with Management Capability (PEMC).

A relay WTRU may interact with a network function (NF) indicating it supports N3GPP for a given application. The relay WTRU may register at the 5GC with its capabilities that it supports N3GPP access, in addition to standard ProSe or PIN capabilities. The relay WTRU may receive a discovery code which may indicate N3GPP direct connection is possible (e.g. an appendix in the discovery), a type of supported direct connection (e.g. BT or WiFi), and N3GPP QoS information. The relay WTRU may broadcast a ProSe Discovery Code for N3GPP access over a PC5 link. The relay WTRU may broadcast the ProSe Discovery Code over N3GPP access. The relay WTRU may receive a Discovery Request message (e.g. with QoS information) or a direct link connection establishment request (e.g. with an indication that direct connection is for N3GPP). 3GPP radio bearers may be in a suspended state or long DRX state. The relay WTRU may establish a PDU session with the network (e.g. indication in the PDU session that connection is for N3GPP communication) with authorization from the 5GCN. The relay WTRU may exchange ProSe keep alive messages with the remote WTRU, indicating that N3GPP communication is still occurring. The relay WTRU and remote WTRU may perform a procedure for bootstrapping of N3GPP access security over a PC5 unicast link to exchange security credentials.

Discovery of ProSe over N3GPP and establishment of a N3GPP connection for ProSe direct communication may comprise providing necessary information for a WTRU to find a peer WTRU with N3GPP access and establish a connection to the peer WTRU. In an embodiment, a new network entity may be used which may be responsible for providing information for discovery of ProSe over N3GPP. The new network entity (e.g. a network function (NF)) may be a logical entity. The new network entity may be implemented by other existing network functions or servers (e.g. PCF, DDNMF, or ProSe Server, AMF, SMF). In an embodiment, an existing PC5 discovery procedure may be reused with piggybacked information for discovery of ProSe over N3GPP.

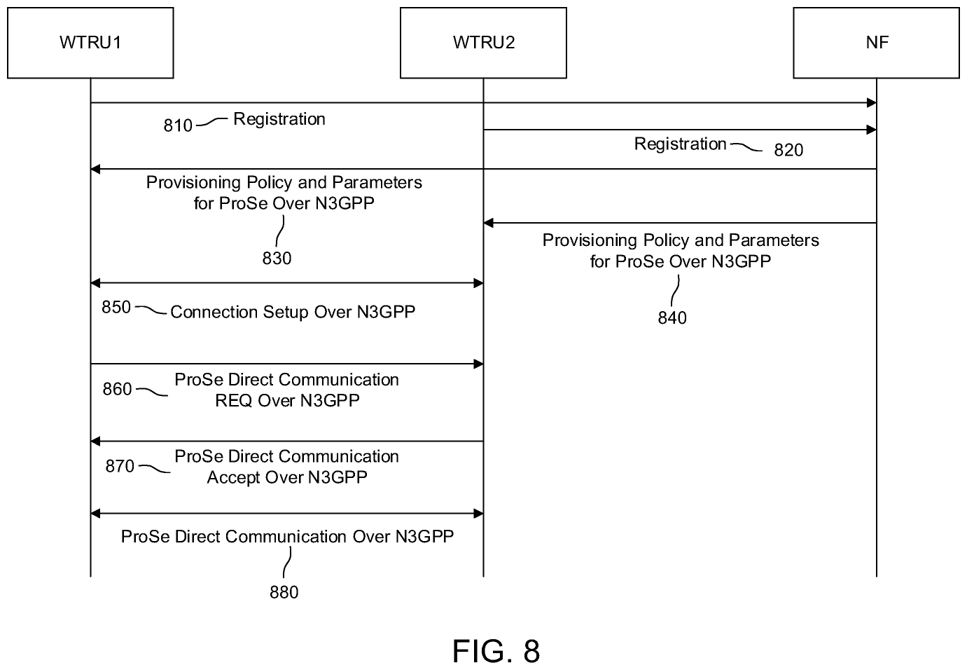

FIG. 8 shows a method of provisioning and connection establishment via 3GPP PC5 signaling using a new logical network entity. Registration may be performed between the WTRUs and the network function (NF) 810, 820. WTRU1 and WTRU2 may send their capabilities for N3GPP access at initial registration to the 5G core network 5GCN (e.g. AMF).

Provisioning of policy information and parameters for ProSe over N3GPP may be performed 830, 840. When WTRU1 and WTRU2 are authorized to use a ProSe service over N3GPP, WTRU1 and WTRU2 may receive policy and parameter information for ProSe over N3GPP. WTRU1 and WTRU2 may receive the policy and parameter information from, for example, a the Policy and Control Function (PCF) or Direct Discovery Name Management Function (DDNMF). The WTRUs may discover a peer WTRU or relay using ProSe over N3GPP according to the policy and parameter information provided from the 5GCN. This information may be provided during the registration procedure or a separate procedure (e.g. WTRU configuration procedure) after registration. The policy and parameter information may comprise, for example, a supported N3GPP connection type, such as WiFi or BT, supported ProSe application information, and identification (ID) for N3GPP access, such as BT ID, SSID, and/or MAC Address. The policy and parameter information may also comprise a supported security mode of N3GPP and security credential information or parameters to derive security credential information to be used to establish a connection. The policy and parameter information may also comprise whether a ProSe Relay Service over N3GPP access is supported. Per application (e.g. ProSe App ID) which WTRUs are authorized to use, the available N3GPP connection may be different. The network entity may limit information to the relevant WTRUs according to a geographical condition such as WTRU location and allowed service area for the ProSe Applications, or allowed ProSe Applications of the requesting WTRU.

A connection setup procedure over N3GPP may be performed 850. Using the provided policy and parameter information, WTRU1 may discover a peer WTRU or a relay WTRU (e.g. WTRU2) supporting a desired ProSe Application over N3GPP and attempt a connection setup procedure over N3GPP with the discovered WTRU. If WTRU1 wants to discover a relay WTRU over N3GPP, it may discover peer WTRUs supporting relay over N3GPP using the policy and parameter information provided from the 5GCN. Additionally, a discovery message may be broadcasted (e.g. announce message (Model A) by WTRU2 or solicitation message (Model B) by WTRU1) and the discovery message may include an indication that discovery is being performed for N3GPP communication between WTRU1 and WTRU2. This may be included as part of the discovery codes broadcasted by WTRUs. When a security procedure is needed for connection setup over N3GPP, WTRU1 and WTRU2 may perform a security procedure using the security mode indicated in the policy and parameter information for ProSe over N3GPP. The WTRUs may derive any security credentials for the security procedures over N3GPP with the input values included in the policy and parameter information for ProSe over N3GPP.

WTRU1 or WTRU2 may send, over the established N3GPP connection, a ProSe direct communication request (REQ) (i.e., 3GPP PC5 signaling message) to WTRU2 or WTRU1, respectively 860. The direct communication request may include a source layer 2 ID, a target layer 2 ID for the requested unicast connection, ProSe Service information, and expected application information. Some information such as ProSe Service information and expected application information may be shared later after a ProSe unicast connection is setup.

WTRU1 or WTRU2, respectively, may respond with a ProSe direct communication accept message 870. The direct communication accept message may include QoS information of the established unicast connection (e.g. information about PC5 QoS flows such as PFI, PQI, and other QoS parameters). Since the WTRUs are aware the ProSe connection is being established for N3GPP direct communication, the ProSe layer on both WTRUs may store this information. Since the ProSe connection is established over N3GPP access, PC5 radio bearers may not be established. Alternatively, the WTRUs may establish the PC5 radio bearers but indicate to each other that the bearers are established in suspended state or in long DRX state (DRX value may be exchanged between the WTRUs). The QoS information may be passed to the N3GPP layer in the WTRU. The source and target L2 ID may be stored by the WTRUs since they may be used when the connection is switched from N3GPP communication to 3GPP PC5 user communication.

WTRU1 and WTRU2 may exchange traffic over the established N3GPP connection 880. The WTRUs may exchange ProSe signaling (e.g., Keep Alive messages) with a N3GPP indication. WTRU1 and WTRU2 described in this embodiment may be a remote WTRU and a relay WTRU respectively.

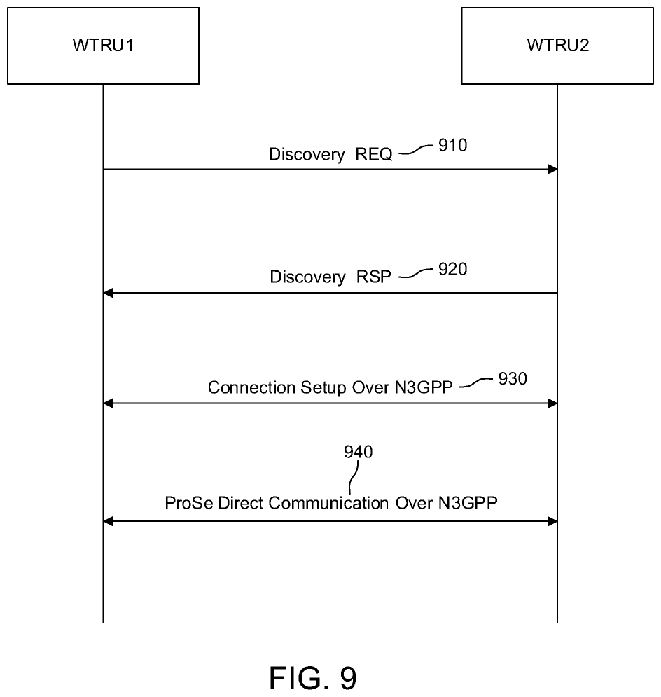

In an embodiment, during a PC5 discovery procedure, information for a N3GPP network connection may be exchanged. The information may include a type of direct connection (e.g. BT or WiFi and identifier information for the N3GPP service such as MAC Address, BT ID, or WiFi SSID). FIG. 9 shows an example method of discovery and connection establishment via N3GPP PC5 signaling.

It may be assumed that WTRU1 and WTRU2 are provisioned with an authorized N3GPP list for ProSe service and information such as a discovery code which may indicate N3GPP direct connection is possible.

A WTRU (WTRU1) may send a ProSe discovery request (REQ) message to discover a peer WTRU (WTRU2) supporting a desired ProSe Application over N3GPP access using a discovery code 910. The ProSe discovery request message may be sent over a PC5 connection. The ProSe discovery request message may include N3GPP information such as an indication that ProSe over N3GGP is supported, a supported N3GPP connection type (e.g. WiFi or BT), supported ProSe Application information over ProSe over N3GPP, and ID for N3GPP Access such as BT ID, SSID, and/or MAC address. The N3GPP information may also include support of a ProSe Relay Service. The N3GPP information may also be a pointer (e.g. discovery code) to the N3GPP provisioning information for a particular ProSe Application received by the WTRUs during a network provisioning procedure.

When a peer WTRU (WTRU2) receives the ProSe discovery request, the peer WTRU (WTRU2) may respond with a ProSe Discovery Accept or Response (RSP) message 920. The ProSe Discovery Accept message may be sent over a PC5 connection. The ProSe Discovery Accept message may include the peer WTRU's (WTRU2 's) supported ProSe over N3GPP connection information such as N3GPP connection type, supported ProSe Application information over ProSe, and ID for N3GPP Access.

After receiving a ProSe Discovery Accept message, the WTRU (WTRU1) or the peer WTRU (WTRU2) may initiate a N3GPP connection setup over the N3GPP access 930.

The WTRU (WTRU1) or peer WTRU (WTRU2) may send, over the established N3GPP connection, a ProSe Direct Communication Request message to the peer WTRU (WTRU2) or the WTRU (WTRU1), respectively 940. The ProSe Direct Communication Request message may include a source layer 2 ID and a target layer 2 ID for the requested direct (unicast) connection, ProSe Service information, expected application information, and security information. The peer WTRU (WTRU2) or the WTRU (WTRU1), respectively, may respond with a ProSe Direct Communication Accept message 940. The ProSe Direct Communication Accept message may include QoS information of the established unicast connection (e.g. information about PC5 QoS flows such as PFI, PQI, and other QoS parameters). The WTRU (WTRU1) and peer WTRU (WTRU2) may exchange traffic over an established ProSe unicast connection 940. WTRU1 and WTRU2 may be a remote WTRU and a relay WTRU respectively.

When a ProSe over N3GPP connection is established, based on an environment change such as WTRU mobility (e.g. a WTRU moves out of a provisioned N3GPP area for a specific ProSe Application), WTRU power status, or channel condition, it may not be possible to keep a connection over a current N3GPP access or other N3GPP access or a PC5 channel may provide a better connection. It may be desirable to change N3GPP access while maintaining a ProSe connection.

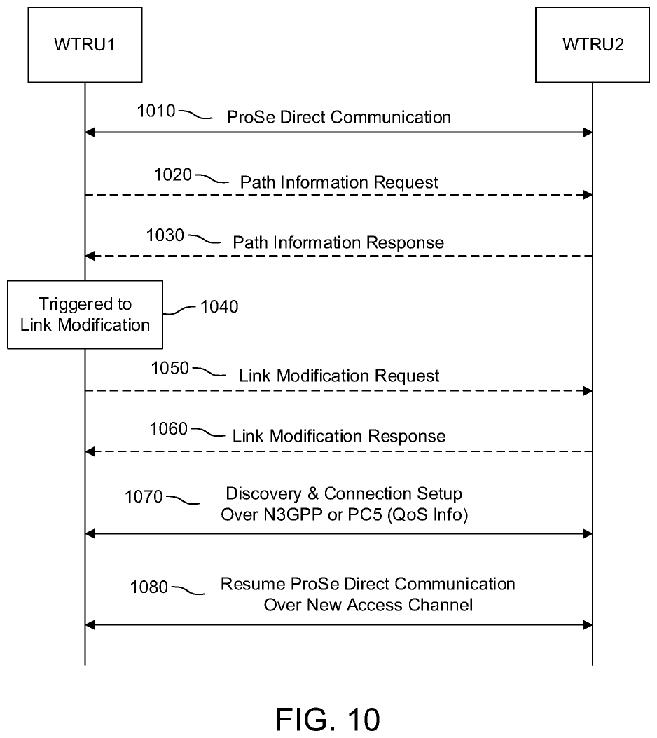

FIG. 10 shows an example method of switching direct communication between 3GPP and N3GPP access.

When WTRU1 and WTRU2 are involved in a ProSe over PC5 connection or N3GPP connection, each WTRU may monitor an access link for a current ProSe connection and/or perform keep alive procedure (e.g. send a keep alive message) 1010. The keep alive message may include a N3GPP indication. Each WTRU may save the other WTRU's supporting N3GPP information (e.g. type of direct connection such as BT or WiFi, identifier information for the N3GPP service such as MAC Address, BT ID, or WiFi SSID, and discovery code for ProSe over N3GPP with supported ProSe application).

If WTRU2 's supporting N3GPP information is not available in WTRU1 or if WTRU1 wants to check again WTRU2 's supporting N3GPP information, WTRU1 may send a message, for example, a path information request message (Path Info REQ) for supporting N3GPP information 1020. WTRU1 may include WTRU1 ′s supporting N3GPP information in the Path Info REQ message.

In response to WTRU2 receiving the Path Info REQ message from WTRU1, WTRU2 may respond with a message, for example, a path information response message (Path Info RSP) with WTRU2 's supporting N3GPP information 1030. If the received Path Info REQ message includes WTRU1 's supporting N3GPP information, WTRU2 may store it for future use.

When WTRU1 may be triggered to a link modification for a RAT (radio access technology) change 1040, it may determine possible N3GPP access with WTRU2 by comparing saved WTRU2 's supporting N3GPP information and its available N3GPP information. WTRU 1 may be triggered by an application layer or based on observed link quality or preferences (e.g. N3GPP is preferred over PC5) configured by a user or the network via a policy provisioning.

WTRU1 may send a Link Modification request (REQ) message to WTRU2 for a link modification from a current RAT to another RAT 1050. WTRU1 may include a target candidate N3GPP access list in the Link Modification REQ message. The target candidate N3GPP access list may include other N3GPP RATs or PC5 access. When the Link Modification REQ message is sent, if WTRU1 does not have WTRU2 's supporting N3GPP information, WTRU1 may include an indication that WTRU2 's supporting N3GPP information is requested. WTRU1 may include WTRU1 's supporting N3GPP information in the Link Modification REQ message.

WTRU2 may send a Link Modification response (RSP) message to WTRU1 with target N3GPP access information 1060. WTRU2 may include WTRU2 's supporting N3GPP information if, for example, it was requested in the Link Modification REQ message.

Based on target N3GPP access information received from WTRU2 and WTRU2 's supporting N3GPP information, WTRU1 may attempt to discover WTRU2 in the target N3GPP access 1070. After discovering WTRU2, WTRU1 may trigger a connection setup over the target N3GPP access with WTRU2. If a Link Modification REQ/RSP message was not exchanged before, WTRU1 may determine a target candidate N3GPP access list based on WTRU2 's supporting N3GPP information and WTRU1 may select a RAT as a target N3GPP access from the target candidate N3GPP access list to discover WTRU2. The target candidate N3GPP access list may include PC5 access. If WTRU2 is not discovered in the selected RAT, WTRU1 may select another RAT as a target N3GPP access from the target candidate N3GPP access list. If the target N3GPP access information includes PC5 access, WTRU1 and WTRU2 may perform discovery and connection setup procedure over PC5. Over an established connection, WTRU1 and WTRU2 may exchange a Direct Communication Request message and a Direct Communication Response message. WTRU1 and WTRU2 may update QoS information of the ProSe connection accordingly.

Data traffic may be exchanged over the new ProSe connection and the previous ProSe connection may be released 1080.

In an embodiment, a WTRU may send a ProSe Link Modification message either over 3GPP or N3GPP access with an indication of switching from N3GPP access to 3GPP for communication. This indication may be sent in, for example, a keep alive message, a Link Identifier Update message, or a Direct Link Security Mode message. Using the Link Identifier Update messages allows changing the WTRU's identifiers (e.g., L2 IDs, security IDs) while doing the switch to the other access, which may prevent tracking/tracing of the WTRU from one access to another one. Using the Direct Link Security Mode messages allows the establishment of security for the ProSe connection when switching to 3GPP access. The Direct Link Security Mode procedure may also be triggered during any of the procedures specified herein, when switching to 3GPP access. When the receiving WTRU acknowledges the request to switch from N3GPP access to 3GPP access or vice versa (e.g. via an indication), the WTRU may decide to switch the connection. An acknowledgment message may be sent by, for example a response message of a Link Modification, Keep Alive, Link Identifier Update, or Direct Link Security Mode, depending on what the other WTRU has sent. When the access is switched from N3GPP to 3GPP PC5 communication, the ProSe layer may pass the QoS information and other communication parameters (e.g. L2 IDs) to the AS layer of the WTRU. The AS layer may establish PC5 radio bearers for 3GPP PC5 communication between the WTRUs. When the access is switched from 3GPP to N3GPP communication, the ProSe layer may send such indication to the AS layer. The AS layer may then deactivate, suspend or use a long DRX for the 3GPP PC5 radio bearers between the WTRUs.

WTRU1 and WTRU2 may resume ProSe Direct Communication over the new access channel.

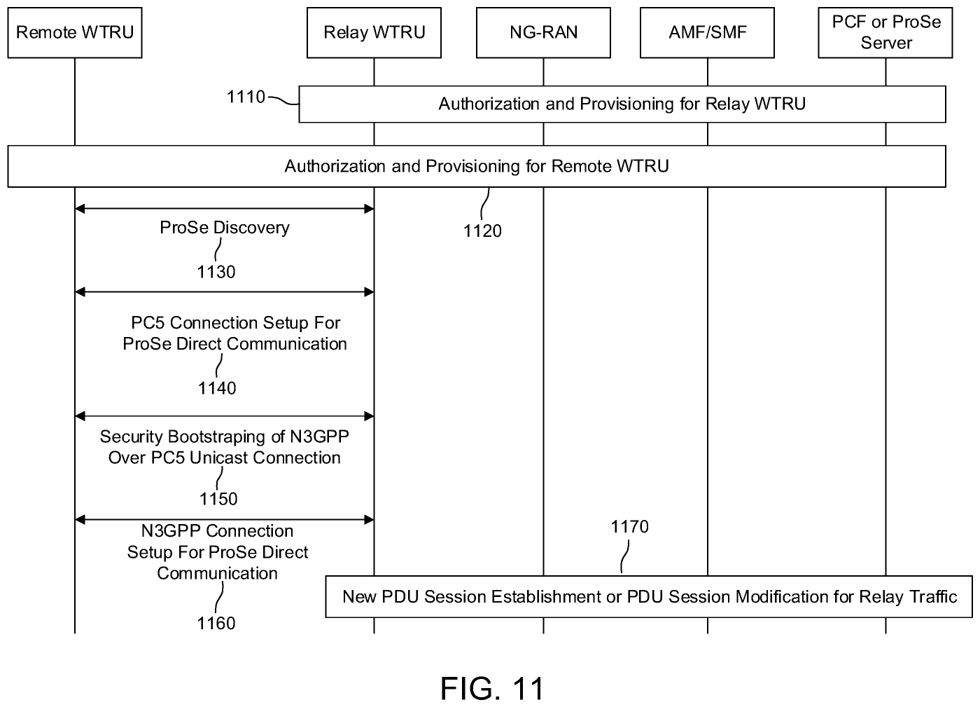

In an embodiment, a relay WTRU may communicate with a 5GCN for establishing a PDU session for a WTRU-to-NW Relay over N3GPP. FIG. 11 shows an example method of establishing a relay connection for N3GPP direct communication.

For authorization and policy provisioning, a relay WTRU may send a message to a network entity/network function (NF) (e.g. AMF, SMF, PCF, ProSe server, DDNMF, or Unified Data Management (UDM)) that indicates it supports Relay for ProSe Service over a N3GPP connection and the relay WTRU may receive authorization to act as a relay WTRU for ProSe Service over a N3GPP connection (1110). The relay WTRU may get provisioned (e.g. receive information) with policy information such as ProSe Application and Service information, a Relay Service Code (RSC) associated with the ProSe Application and Service information, and other policy information for ProSe WTRU-to-NW Relay over N3GPP. The policy information may include information such as which N3GPP access technologies may be supported and which technologies among them may be used simultaneously. The policy information may include identity information which may be used to identify the entity in the N3GPP access technology (e.g. SSID of WIFI), supported security mode for each supported N3GPP access technology, and security credential information or parameters to derive security credential information to be used to establish a connection with a remote WTRU over the N3GPP access technology. The PCF or ProSe Server may provide this information to the relay WTRU. This information may be transferred through the AMF and NG-RAN to the relay WTRU. The ProSe Server may provide this information to the 5GCN which may be handled by the PCF. The relay WTRU may receive this information via a user plane connection over a PDU session.

A remote WTRU may send a message to a network entity/network function (NF) (e.g. AMF, SMF, PCF, ProSe Server, DDNMF, UDM) that indicate it supports Relay for ProSe Service over a N3GPP connection and the remote WTRU may receive authorization to act as remote WTRU for ProSe Service over a N3GPP connection 1120. The remote WTRU may get provisioned (e.g. receive provision information) with policy information such as ProSe Application and Service information which the remote WTRU is allowed to use, a Relay Service Code (RSC) associated with the ProSe Application and Service information, and other policy information for accessing ProSe WTRU-to-NW Relay over N3GPP. The policy information may include information such as which N3GPP access technologies may be supported and which technologies among them may be used simultaneously with ProSe WTRU-to-NW Relay over N3GPP. The policy information may include identity information which may be used to identify the Rely WTRU entity in the N3GPP access technology (e.g. SSID of WiFi), a supported security mode for each supported N3GPP access technology, and security credential information or parameters to derive security credential information to be used to establish a connection with a relay WTRU over the N3GPP access technology. The PCF or ProSe Server may provide this information to the remote WTRU. This information may be transferred through the AMF and NG-RAN to the remote WTRU. The ProSe Server may provide this information to the 5GCN which may be handled by the PCF. The relay WTRU and the remote WTRU may receive supported QoS information (e.g. latency or data rate) and other QoS per ProSe application for the N3GPP connection. The QoS information may be received from the ProSe server via the PCF.

Based on a location and/or a time, an available relay WTRU information (e.g. a list) and a supported N3GPP access technology of each relay WTRU may be different. Therefore, the PCF may provide different policy information to the remote WTRU or to the relay WTRU per location and time and a validity condition including location and time.

For a ProSe discovery procedure, the relay WTRU may broadcast discovery information over a PC5 connection 1130. The discovery information may include, for example, a RSC for ProSe WTRU-to-NW Relay, an indication of N3GPP access support, a list of supported N3GPP access technologies, and a related security mode. A N3GPP access technology specific identification information of the relay WTRU may be included in the broadcast discovery information. The N3GPP access technology specific identification information of the relay WTRU may be shared during a ProSe link establishment procedure over the PC5 connection.

A PC5 connection may be setup for ProSe direct communication between the remote WTRU and the relay WTRU 1140. When the remote WTRU finds a RSC which belongs to the list of RSC allowed for the remote WTRU, the remote WTRU may initiate a PC5 connection setup for ProSe direct communication with the relay WTRU which broadcasted the RSC. For example, the remote WTRU may send a request message to the relay WTRU (e.g. a ProSe Direct Communication Request (DCR) message) for setting up a PC5 unicast connection for ProSe Direct communication. The relay WTRU may send a response message to the remote WTRU (e.g. a ProSe Direct Communication Accept (DCA) message). The relay WTRU and remote WTRU may establish a security association to protect the established PC5 unicast connection. The relay WTRU may set up a new PDU session for the relay service of the remote WTRU or may reuse an existing PDU session for the relay service of the remote WTRU. The PDU session may be used for relaying traffic from the remote WTRU, sent over the PC5 unicast connection, toward the network over the PDU session and for receiving traffic from the network over the PDU sessions for relaying traffic to the remote WTRU over the PC5 unicast connection.

Security bootstrapping of N3GPP access may be performed 1150. The security bootstrapping may be performed to prepare security credentials to be used for setting up security associations between the remote WTRU and the relay WTRU over N3GPP. The remote WTRU and relay WTRU may perform security bootstrapping of N3GPP access over the PC5 unicast connection.

For the security bootstrapping procedure, the remote WTRU and relay WTRU may exchange signaling or messages over the PC5 unicast connection to share security credentials for the security mode operation of the N3GPP access technology. This may be done during the PC5 connection setup for ProSe direct communication procedure (e.g. using a direct communication request (DCR) message, a direct security mode (DSM) Command message, a DSM Complete message or a direct communication accept (DCA) message) or after the PC5 connection setup procedure (e.g. using a Link Modification message or a Direct link Re-keying message). For example, the relay WTRU and remote WTRU may share a symmetric key for accessing the remote WTRU over WiFi technology with a WEP security protocol.

Based on the security mode operation of the N3GPP access technology, the remote WTRU and relay WTRU may perform a different signaling or message exchange for required security protocol to exchange different security parameters and share security credentials. The remote WTRU may use the security credentials provided by the network (e.g. PCF, ProSe server, DDNMF) or derived with the parameters provided by the PCF/ProSe server to access the relay WTRU over the N3GPP access technology. The remote WTRU and relay WTRU may exchange security credentials with assistance from a ProSe server which may be dedicated to the security credentials management. For example, a ProSe server may identify a remote WTRU and relay WTRU, check the validity and authenticity of each WTRU, and provide security credentials or security parameters to derive security credentials to each WTRU.

When sharing security credentials between a remote WTRU and relay WTRU, the relay WTRU and/or 5GCN may use security credentials of the remote WTRU at a 3GPP system to check the validity of the remote WTRU and derive security credentials for accessing the relay WTRU over N3GPP access.

After successful sharing of security credentials between the remote WTRU and relay WTRU, the remote WTRU may communicate with the relay WTRU over N3GPP access using the shared security credentials and may initiate a ProSe link establishment procedure (e.g. using a DCR, DSM Command, DSM Complete, or DCA message) over N3GPP access (i.e. N3GPP connection setup for ProSe direct communication) or switch the established PC5 connection for ProSe communication to N3GPP access 1160.

For PDU session management for access over PC5 and N3GPP in, for example, a L3 WTRU-to-NW Relay, the relay WTRU may establish a PDU Session for relaying service of the remote WTRU 1170. During or after a unicast link setup (e.g. ProSe Link Establishment procedure), the remote WTRU may send information to the relay WTRU such as a requested DNN, IP type, SSC mode, QoS information for the expected relay service from the relay WTRU. In consideration of QoS requirements and requested parameters from the remote WTRU, the relay WTRU may establish a PDU session for relaying service over the N3GPP access or the relay WTRU may reuse or modify an existing PDU session for relaying service over N3GPP access regardless of access technologies. Based on the QoS information for ProSe service over N3GPP, the relay WTRU may modify an existing PDU session or establish a new PDU session for WTRU-to-NW Relay over N3GPP with the remote WTRU. During a PDU session setup or modification procedure, the relay WTRU may send information to the SMF that the ProSe connection was setup over a N3GPP connection and the QoS information over the N3GPP connection. The SMF may update QoS characteristics of the PDU session according to characteristics of a reported N3GPP connection and supported QoS information.

The relay WTRU may send information to the remote WTRU regarding whether a new PDU session is assigned or an existing PDU session will be reused or modified. The remote WTRU may receive information from the relay WTRU regarding supported QoS characteristics of the N3GPP link or PC5 link. The relay WTRU may send information regarding the maximum bit rate limit to the remote WTRU for relay access for PC5, N3GPP link, or for all links.

When a dedicated PDU session for relay service over the N3GPP access is established, the relay WTRU may be assigned with or receive information regarding parameters of an aggregated maximum bit rate (AMBR) over the PDU session (e.g. session AMBR) during the PDU session establishment. The relay WTRU may manage the N3GPP access with the remote WTRU so that the bit rate of the PDU session for the relay service does not exceed the session AMBR. The AMBR for the PDU session (i.e. Session AMBR) belongs to the PDU session related parameters which may be sent by the SMF. The PDU session related parameters may be included in a PDU session establishment response message or a PDU session modification response message sent by the SMF and received by relay WTRU. The relay WTRU may send information to the remote WTRU regarding the maximum bit rate limit for N3GPP access for the remote WTRU less than or equal to the session AMBR.

When an existing PDU session for relay service is to be used for the relay service over the N3GPP access, the relay WTRU may manage and ensure that the sum of the data rate over the PC5 link and the data rate over the N3GPP link does not exceed the session AMBR. The relay WTRU may send information to the remote WTRU regarding a maximum bit rate limit of PC5 and a maximum bit rate limit of N3GPP individually or the relay WTRU may send information regarding a maximum bit rate limit of the sum of both PC5 and NG3GPP access. The sum of the maximum bit rate limits may not exceed the session AMBR.

Transmission over PC5 and N3GPP access for relay services may be performed simultaneously. A remote WTRU and a relay WTRU may manage a PC5 unicast connection and a N3GPP unicast connection together. Based on QoS requirements and policies, each unicast connection may be mapped to a different PDU session of a relay WTRU or each unicast connection may be mapped to a PDU session of a relay WTRU. When a PDU session of a relay WTRU is used for a PC5 unicast connection and N3GPP unicast connection, the remote WTRU may decide to assign each data flow to a unicast connection or use multiple unicast connections for a data flow. When multiple unicast connections are used for a data flow, the remote WTRU may manage traffic split and steering.

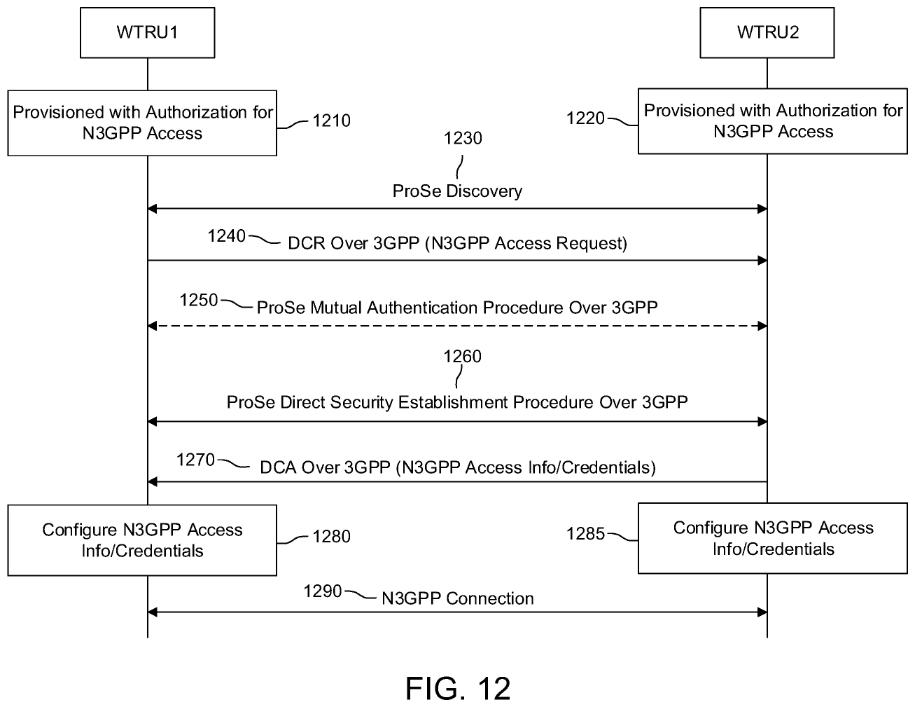

FIG. 12 shows an example method of 3GPP PC5 assisted discovery and N3GPP link establishment. In this embodiment, a remote WTRU and a relay WTRU may use enhanced 3GPP PC5 link establishment procedures to assist in the N3GPP access discovery and connection procedures. The terms remote WTRU and relay WTRU may be used. The WTRUs may be peer WTRUs engaged in direct communication or a peer WTRU engaged in communication with a WTRU-to-Network relay. WTRU1 may be a remote WTRU. WTRU2 may be a WTRU-to-NW relay and/or have AP functionality.

A remote WTRU (WTRU1) may be provisioned with or receive authorization information to use a N3GPP connection 1210. A relay WTRU (WTRU2) may be provisioned with or receive authorization information to use a N3GPP connection 1220. The authorization information may include an indicator that N3GPP (e.g., WiFi) is supported. The indicator may be associated with an RSC in the case of a WTRU-to-NW relay scenario and the authorization information may include a N3GPP access ID. If configured by the network and if no specific N3GPP access ID is assigned by the network then such access ID may be generated/provided by the relay.

Remote WTRU1 may discover the N3GPP capable relay WTRU2 using a ProSe discovery procedure 1230.

Remote WTRU1 may establish a 3GPP PC5 connection with relay WTRU2 using enhanced link establishment and security procedures to support an additional N3GPP link establishment. Remote WTRU1 may send a N3GPP access request message to relay WTRU2 indicating that it wants to use N3GPP access 1240. The message may be a DCR message and may provide N3GPP access security capabilities (e.g., WPA2 TKIP or AES). The message may be sent via a 3GPP connection.

ProSe authentication and security procedures may be used over the 3GPP access 1250, 1260. Remote WTRU1 and relay WTRU2 may establish credentials needed for the N3GPP access security. Relay WTRU2 may generate a shared secret (e.g., WiFi passphrase) for remote WTRU1 following a successful PC5 Direct Security Mode procedure. Relay WTRU2 may generate a N3GPP access ID (e.g., SSID) if none is provided by the network. Alternatively, both WTRUs may derive a N3GPP access shared key (e.g., PSK) following a successful mutual authentication using a ProSe long term key.

Relay WTRU2 may send, to remote WTRU1, N3GPP access information and credential information 1270. The information may be sent in a protected DCA message and may comprise, for example, a N3GPP access ID, security credentials (e.g., WiFi passphrase as generated above) and/or a N3GPP security type (e.g., WPA2). A ProSe unicast connection may be established over 3GPP.

Remote WTRU1 and relay WTRU2 may configure N3GPP access information and credentials (e.g., generate a PSK using the Passphrase) 1280, 1285.

Remote WTRU1 may establish a secure N3GPP connection with relay WTRU2 1290. Remote WTRU1 may establish the secure N3GPP connection with relay WTRU2 using a conventional N3GPP association/connection procedure using the N3GPP access ID and credentials established with relay WTRU2.

In addition and alternatively to 1250/1260, remote WTRU1 and relay WTRU2 may establish the N3GPP access connection after a 3GPP PC5 link has already been established by using an enhanced 3GPP PC5 link modification procedure. The requesting WTRU may indicate that it wants to use N3GPP access in, for example, a Link Modification Request (LMReq) message. The responding WTRU may provide a N3GPP access ID and credentials as described above in, for example, a protected Link Modification response (LMResp) message.

In a subsequent reconnection with the relay Link Modification, the remote Link Modification may establish directly the ProSe unicast link over N3GPP using the configured/stored N3GPP access information (i.e. skip steps 1240, 1240, 1250, 1270, 1270, and 1280).

The benefits of enabling the remote WTRU and relay WTRU to establish N3GPP access ID and credentials in an ad-hoc fashion as proposed may be as follows: no impact on the network to maintain N3GPP access information across remote WTRUs and relay WTRUs; increased security as the WTRU is able to frequently update N3GPP access credential information (e.g., frequent update WiFi passphrase, SSID); additional layer of privacy with the relay WTRU sending the N3GPP access ID in a protected unicast message. (e.g. remote WTRU and relay WTRU may use a “hidden SSID”); and automated “zero config” of N3GPP tethering using 3GPP ProSe capable devices.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a relay wireless transmit/receive unit (WTRU), the method comprising:
sending, to a network entity, a message indicating support for relay for (Proximity Services) ProSe service over a non-3GPP (N3GPP) connection;
receiving, from the network entity, policy information for WTRU to Network relay over N3GPP, wherein the policy information comprises a relay service code (RSC), N3GPP identity information, and supported security mode for a N3GPP access technology;
broadcasting discovery information, wherein the discovery information comprises the RSC, the N3GPP identity information, and the supported security mode for a N3GPP access technology;
establishing, with a remote WTRU associated with the RSC, a PC5 unicast connection for ProSe direct communication including a security association with the remote WTRU;
performing security bootstrapping of N3GPP access over the PC5 unicast connection with the remote WTRU, wherein the security bootstrapping comprises exchanging messages with the remote WTRU to share N3GPP security credentials, wherein the N3GPP security credentials are based on a supported security mode of the N3GPP access technology;
establishing the N3GPP connection for ProSe direct communication; and
establishing a new protocol data unit (PDU) session or changing an existing PDU session for relaying traffic of the remote WTRU to the network entity.

2. The method of claim 1, wherein the network entity is a 5G core network entity and is at least one of: an Access and Mobility Management Function (AMF), a Session Management Function (SMF), a Policy and Control Function (PCF), a ProSe server, a Direct Discovery Name Management Function (DDNMF), or a Unified Data Management (UDM).

3. The method of claim 1, wherein the policy information comprises at least one of: ProSe application and service information, an indication of which N3GPP access technologies are supported, which N3GPP access technologies may be used simultaneously, and security credential information.

4. The method of claim 3, wherein the RSC is associated with the ProSe application and service information.

5. The method of claim 1, further comprising receiving N3GPP quality of service (QOS) information.

6. The method of claim 1, wherein available relay WTRU information is sent by a policy and control function (PCF) to the remote WTRU and wherein the available relay WTRU information comprises a list of available relay WTRUs and wherein the list of available relay WTRUs is based on a location or time.

7. The method of claim 1, wherein the security bootstrapping is performed using assistance information received from a ProSe server.

8. The method of claim 1, wherein the establishing a new PDU session or changing an existing PDU session is based on quality of service (QOS) information.

9. The method of claim 1, further comprising:
sending information to a session management function (SMF) indicating that the N3GPP connection for ProSe direct communication was established.

10. The method of claim 1, further comprising:
receiving information regarding an aggregated maximum bit rate (AMBR) for a PDU session; and
managing the N3GPP connection with the remote WTRU so that a bit rate of the PDU session does not exceed the AMBR.

11. A relay wireless transmit/receive unit (WTRU) comprising:
a transmitter;
a receiver; and
a processor, wherein:
the transmitter is configured to send, to a network entity, a message indicating support for relay for Proximity Services (ProSe) service over a non-3GPP (N3GPP) connection;
the receiver is configured to receive, from the network entity, policy information for WTRU to Network relay over N3GPP, wherein the policy information comprises a relay service code (RSC), N3GPP identity information, and supported security mode for a N3GPP access technology;
the processor is configured to broadcast discovery information, wherein the discovery information comprises the RSC, the N3GPP identity information, and the supported security mode for a N3GPP access technology;
the processor is further configured to establish, with a remote WTRU associated with the RSC, a PC5 unicast connection for ProSe direct communication including a security association with the remote WTRU;
the processor is further configured to perform security bootstrapping of N3GPP access over the PC5 unicast connection with the remote WTRU, wherein the security bootstrapping comprises exchanging messages with the remote WTRU to share N3GPP security credentials, wherein the N3GPP security credentials are based on a supported security mode of the N3GPP access technology;
the processor is further configured to establish the N3GPP connection for ProSe direct communication; and
the processor is further configured to establish a new protocol data unit (PDU) session or change an existing PDU session for relaying traffic of the remote WTRU to the network entity.

12. The relay WTRU of claim 11, wherein the network entity is a 5G core network entity and is at least one of; an Access and Mobility Management Function (AMF), a Session Management Function (SMF), a Policy and Control Function (PCF), a ProSe server, a Direct Discovery Name Management Function (DDNMF), or a Unified Data Management (UDM).

13. The relay WTRU of claim 11, wherein the policy information comprises at least one of: ProSe application and service information, an indication of which N3GPP access technologies are supported, which N3GPP access technologies may be used simultaneously, and security credential information.

14. The relay WTRU of claim 13, wherein the RSC is associated with the ProSe application and service information.

15. The relay WTRU of claim 11, wherein the receiver is further configured to receive N3GPP quality of service (QOS) information.

16. The relay WTRU of claim 11, wherein available relay WTRU information is sent by a policy and control function (PCF) to the remote WTRU and wherein the available relay WTRU information comprises a list of available relay WTRUs and wherein the list of available relay WTRUs is based on a location or time.

17. The relay WTRU of claim 11, wherein the security bootstrapping is performed using assistance information received from a ProSe server.

18. The relay WTRU of claim 11, wherein the processor is further configured to establish a new packet data unit (PDU) PDU session or change an existing PDU session is based on quality of service (QOS) information.

19. The relay WTRU of claim 11 wherein the transmitter is further configured to send information to a session management function (SMF) indicating that the N3GPP connection for ProSe direct communication was established.

20. The relay WTRU of claim 11, wherein:
the receiver is further configured to receive information regarding an aggregated maximum bit rate (AMBR) for a PDU session; and
the processor is further configured to manage the N3GPP connection with the remote WTRU so that a bit rate of the PDU session does not exceed the AMBR.
